(19) United States
(12) Patent Application Publication
(10) Pub. No.: US 2025/0130697 A1
(43) Pub. Date: Apr. 24, 2025

(54) USER INTERFACES FOR COLLABORATIVE CONTENT PLAYLISTS

(71) Applicant: Apple Inc., Cupertino, CA (US)

(72) Inventor: Agnes WON, Los Angeles, CA (US)

(21) Appl. No.: 18/679,329

(22) Filed: May 30, 2024

Related U.S. Application Data
(60) Provisional application No. 63/506,104, filed on Jun. 4, 2023.

(51) Int. Cl. G06F 3/0484; G06F 3/0482

(52) U.S. Cl. CPC G06F 3/0484; G06F 3/0482

(57) ABSTRACT

Some embodiments described in this disclosure are directed to one or more electronic devices that facilitate interacting with and controlling collaborative playlists and their associated content items on a content application. In some embodiments, one or more users, each user using their own electronic device creates, edits, and maintains a joint media playlist on an electronic device.

### CROSS-REFERENCE TO RELATED APPLICATIONS

This application claims the benefit of U.S. Provisional Application No. 63/506,104, filed Jun. 4, 2023, the content of which is herein incorporated by reference in its entirety for all purposes.

### FIELD OF THE DISCLOSURE

This relates generally to user interfaces that present information and one or more controls for collaborative playlists on an electronic device.

### BACKGROUND

User interaction with electronic devices has increased significantly in recent years. These devices can be devices such as computers, tablet computers, televisions, multimedia devices, mobile devices, and the like.

In some circumstances, such a device facilitates the creation and operation of collaborative content playlists in a content application. In some circumstances, the electronic device presents information about the collaborative playlist in a user interface including the content associated with the collaborative playlist as well as the users that are part of the collaborative playlist. In some circumstances, users wish to view information about the collaborative playlist and interact with the collaborative playlist efficiently. Enhancing these interactions improves the user's experience with the device and decreases user interaction time, which is particularly important where input devices are battery-operated.

### SUMMARY

Some embodiments described in this disclosure are directed to one or more electronic devices that facilitate interaction with a collaborative playlist in a content application. Some embodiments described in this disclosure are directed to one or more electronic devices that facilitate display of a collaborative playlist in a collaborative playlist user interface. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6F illustrate exemplary ways in which an electronic device facilitates displaying information and controlling a collaborative playlist of a content application in a search results user interface in accordance with some embodiments of the disclosure.

FIG. 7 is a flow diagram illustrating a method of a collaborative playlist in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for interacting with a collaborative playlist in a content application. In some embodiments, the electronic device displays information associated with the collaborative playlist at a collaborative content playlist user interface. In some embodiments, while a plurality of users is associated with a collaborative content playlist in a content application, and while displaying, via the display generation component, a user interface associated with the content application via which the collaborative content playlist is accessed, receiving, via the one or more input devices, a first input corresponding to a request to associate a reaction with a content item of the collaborative content playlist. In some embodiments in response to receiving the first input, initiating a process to associate a visual indicator of the reaction with the content item in the collaborative content playlist. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD0, a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

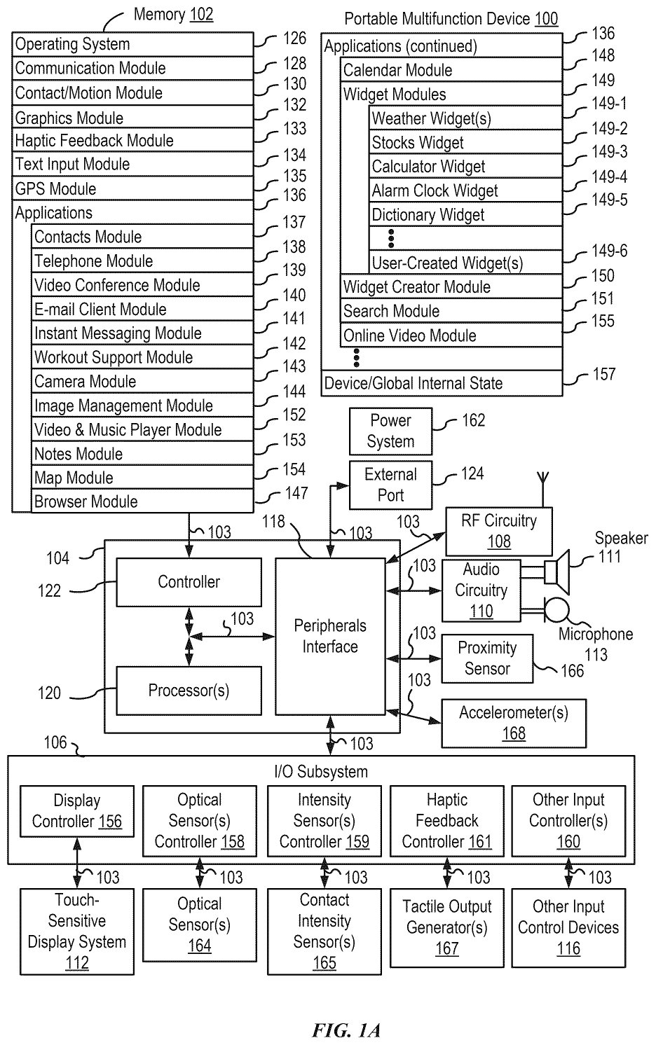

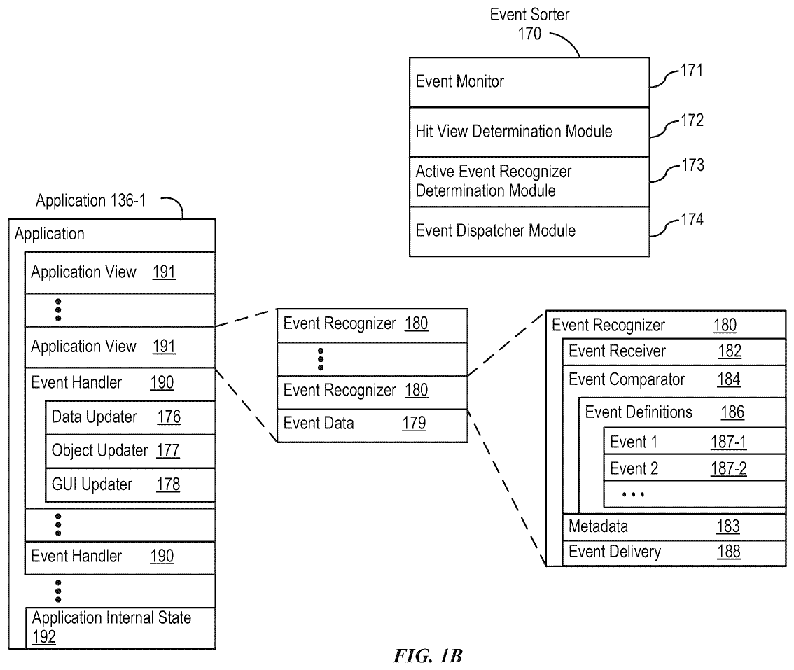

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

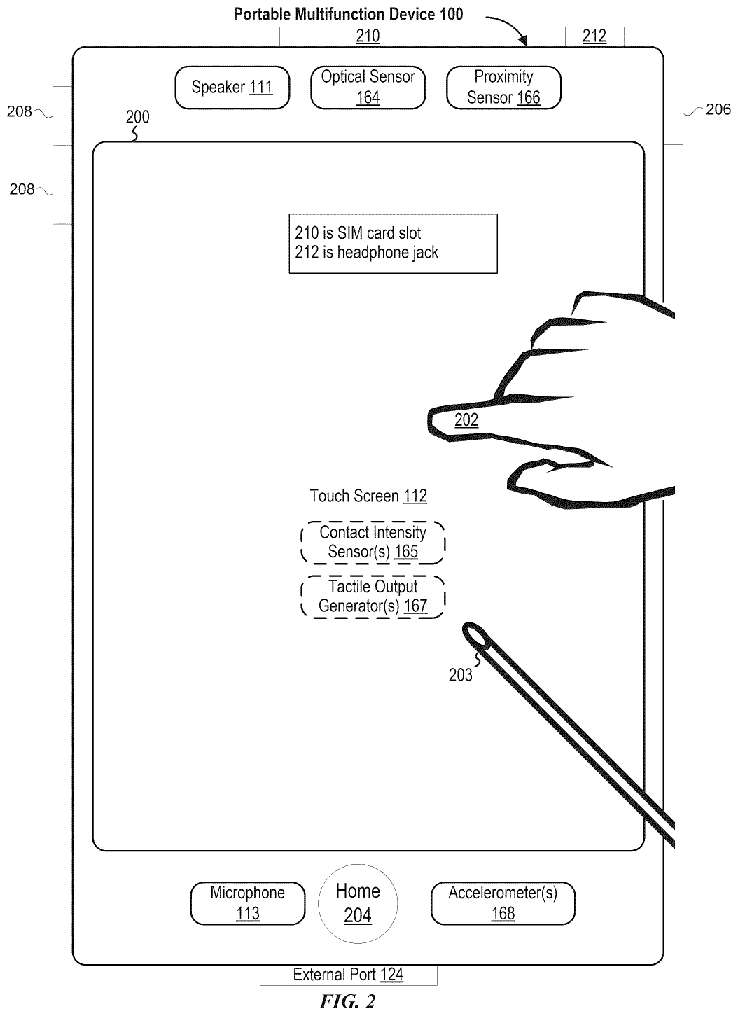

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patents application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

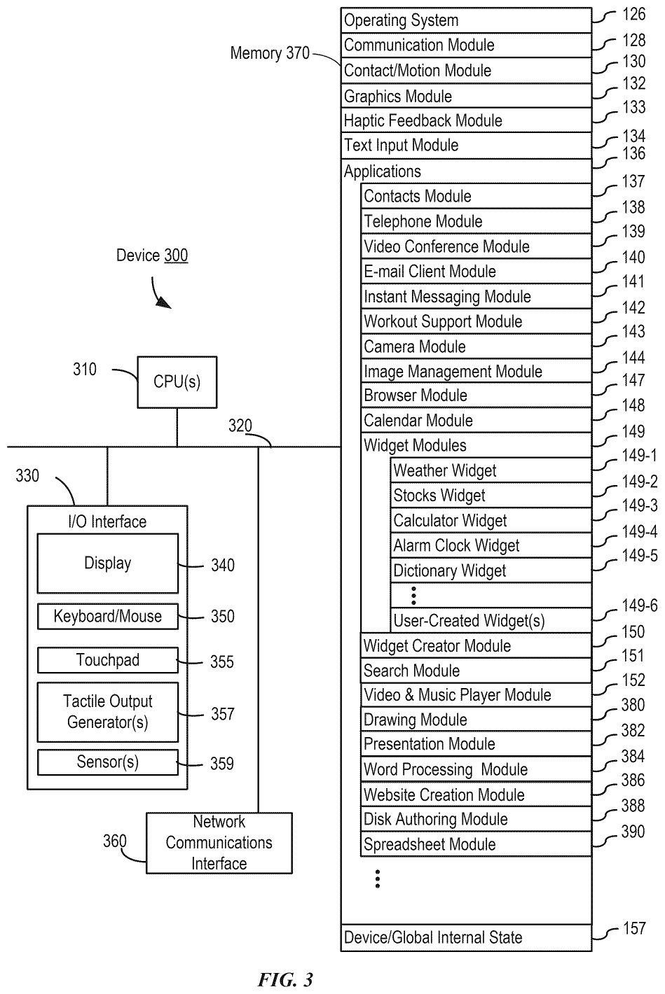

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” /multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562,“Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

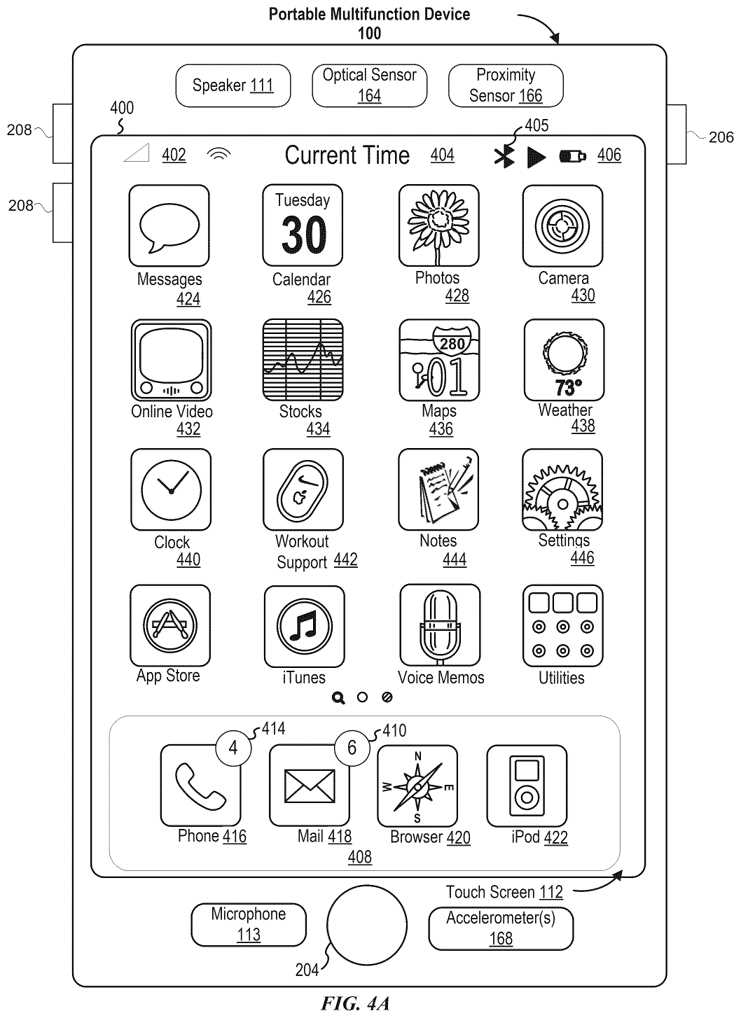

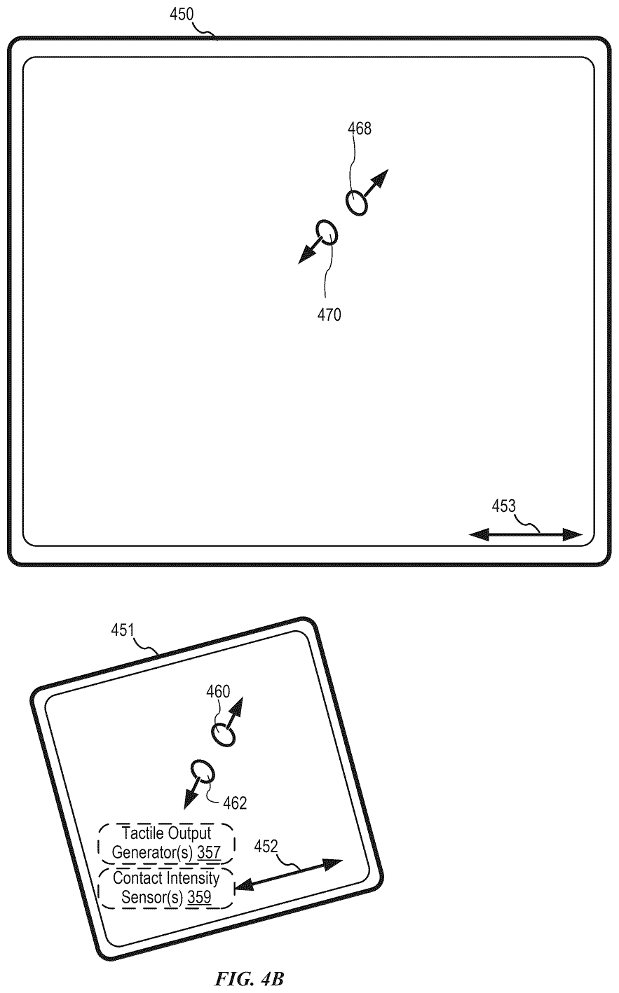

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

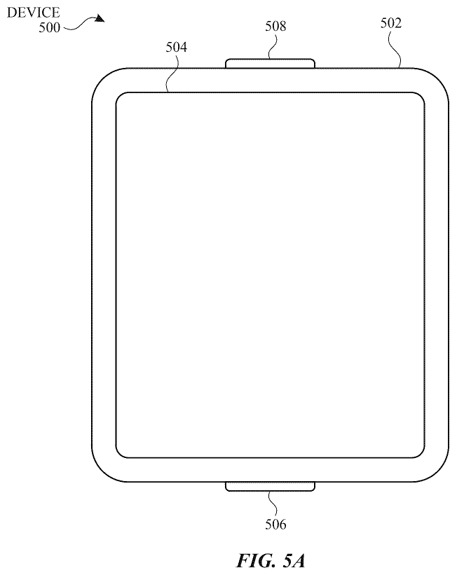

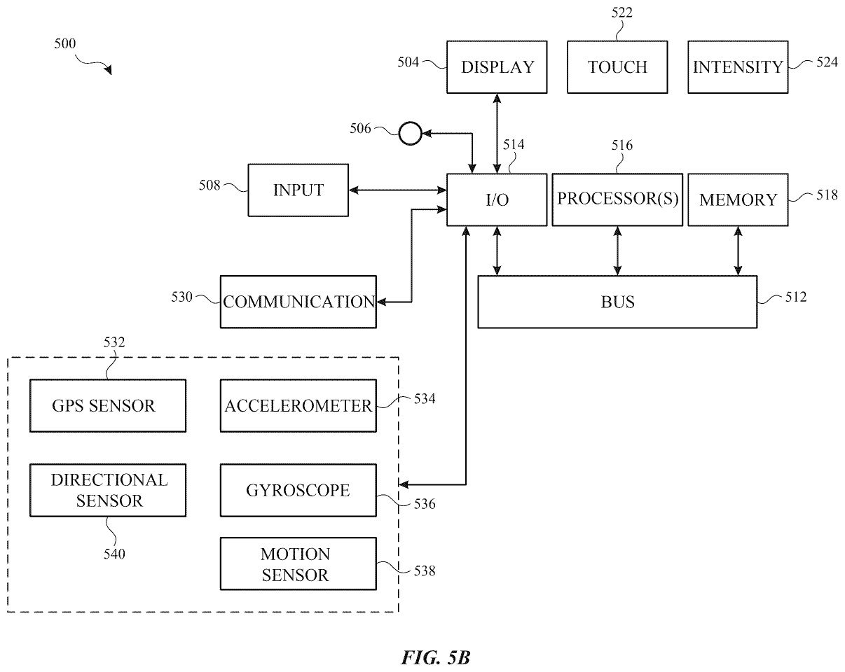

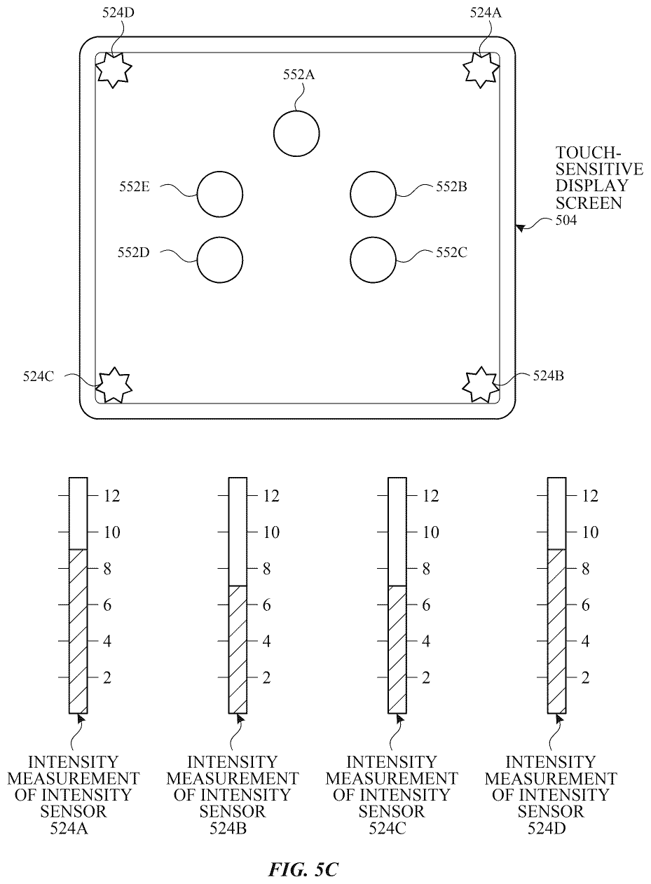

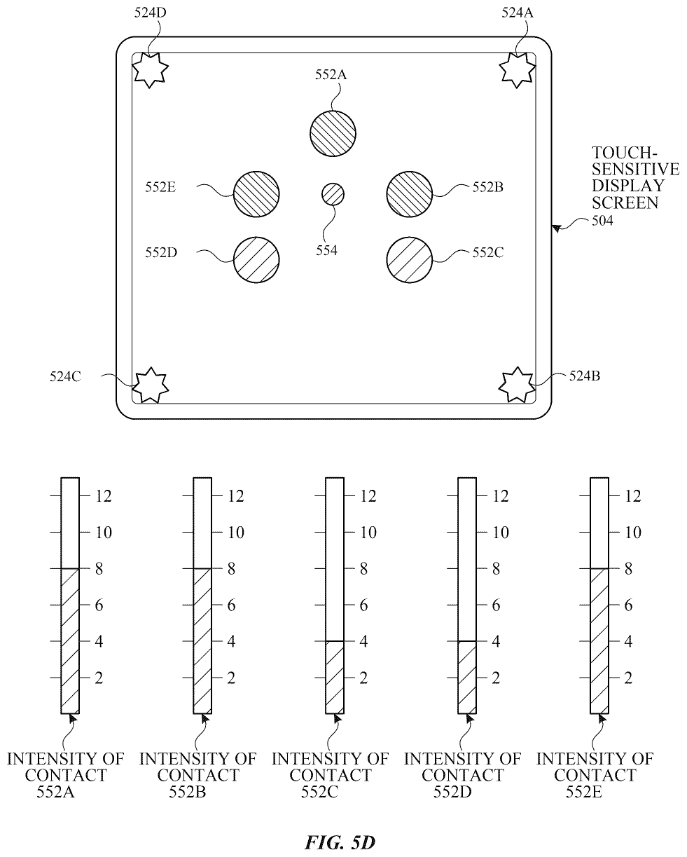

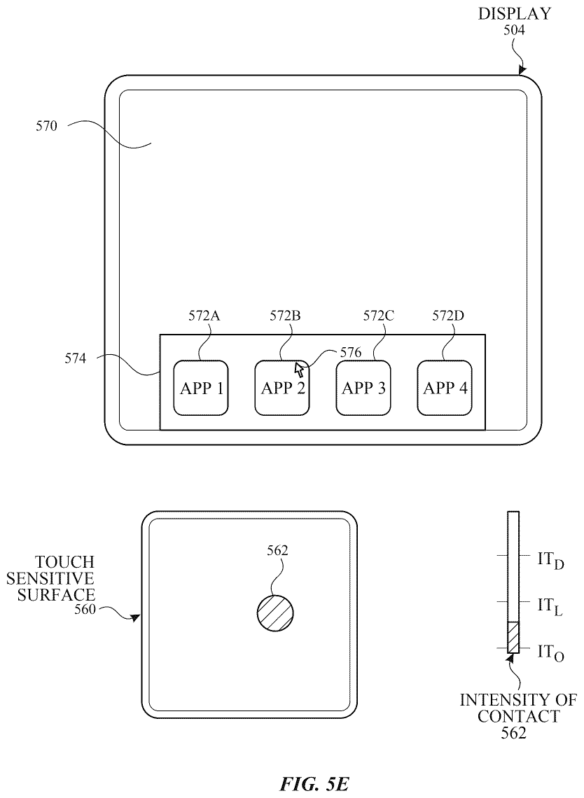

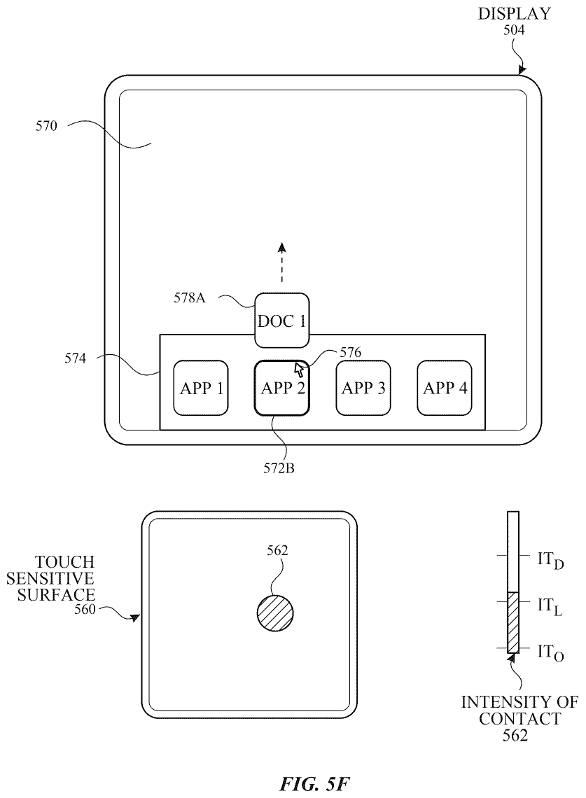

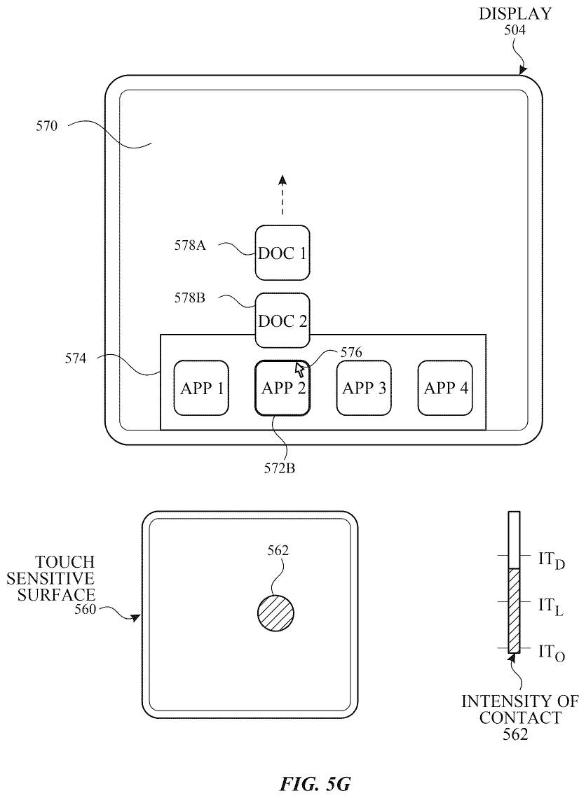

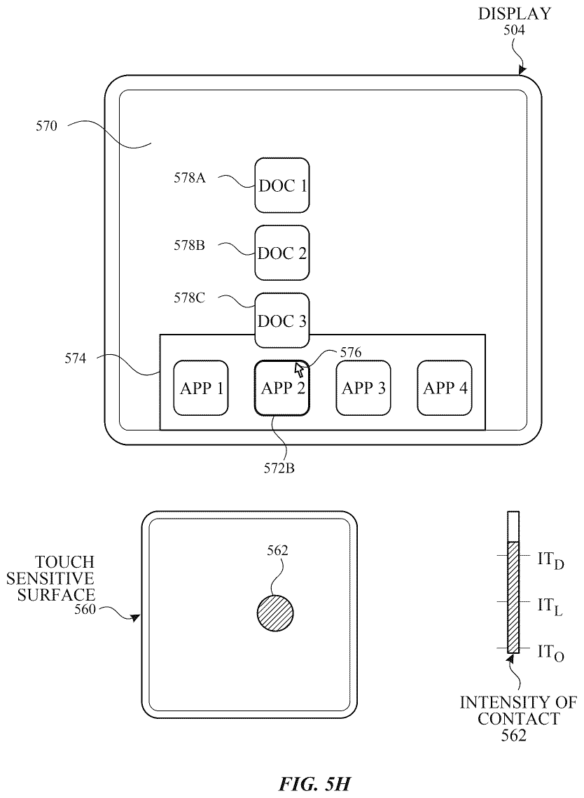

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### User Interfaces for Collaborative Playlists

Users interact with electronic devices in many different manners, including interacting with content applications for organizing and playing content items (e.g., music, videos, podcasts, etc.). In some embodiments, the device displays user interfaces via the content application that facilitate organization of the content items and efficient interaction with the content items. For instance, the content application includes one or more user interfaces that facilitate organization of the content items stored by the device (either internally on the device or on an external memory such as a cloud-based memory) into one or more “playlists.” In some embodiments, a playlist refers to a list of content items that have been selectively placed onto the list by one or more users. In some embodiments, the user of the electronic device creates their own playlists via the content application by selecting content items for inclusion on the playlist. The user can select content items for the playlist based on a variety of factors. For instance, in the example where the content items are music files, the user can create a playlist based around a particular music artist, musical genre, tempo, etc. In some circumstances, the device facilitates the creation of collaborative playlists via the content application. A collaborative playlist is a playlist in which the content items of the playlist have been contributed by a plurality of users (including the user of the device, and other external users) and/or the content items of the playlist are viewable by the plurality of users. In some circumstances, the user of the electronic device (e.g., the host of the playlist) generates a playlist and then invites one or more external users to be collaborators on the playlist. In some embodiments, the playlist can last or be collaborative for a finite period of time (e.g., the duration of a car trip, the duration of a house party, a number of hours or number of days, or the duration of a road trip with potentially multiple stops). Further the playlist may include only user devices in proximity of the host of the playlist or only user devices that are in a communication session with the host of the playlist. The host and/or the collaborators select content items to be included on the playlist, and the content items included on the playlist can be played back on each of the user's devices. In some circumstances, a user that is part of a collaborative playlist does not receive any feedback from the other users/collaborators of the playlist as to whether the content items they have selected for the playlist are acceptable to the other users. For instance, if a particular collaborator adds content to a playlist that is not well received or liked by the other collaborators of the collaborative playlist, the only recourse may be for the host or other authorized person to remove the content items, and in some circumstances revoke the collaborator status of the collaborator. In some circumstances, if the user adds content that is well received by the other collaborators of the collaborative playlist, the user may not receive that feedback and thus may not be encouraged to add additional content that is similar to the content items they have already added. In any of the above circumstances, the user would benefit from receiving feedback from the device via the content application in an efficient manner regarding their selections for the collaborative playlist. Additionally, providing feedback to the collaborators regarding content selections for a playlist can lead to decreased need for user input on the content application (for instance to remove a collaborator) thereby conserving computing and memory resources of the electronic device. The embodiments described below provide ways in which an electronic device provides efficient user interfaces for adding reactions to content items on a collaborative playlist, thus enhancing the user's interaction with the device. In some embodiments, a “reaction” refers to a visual indicator that is used to represent a user's feelings or emotions regarding a content item on a collaborative playlist. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

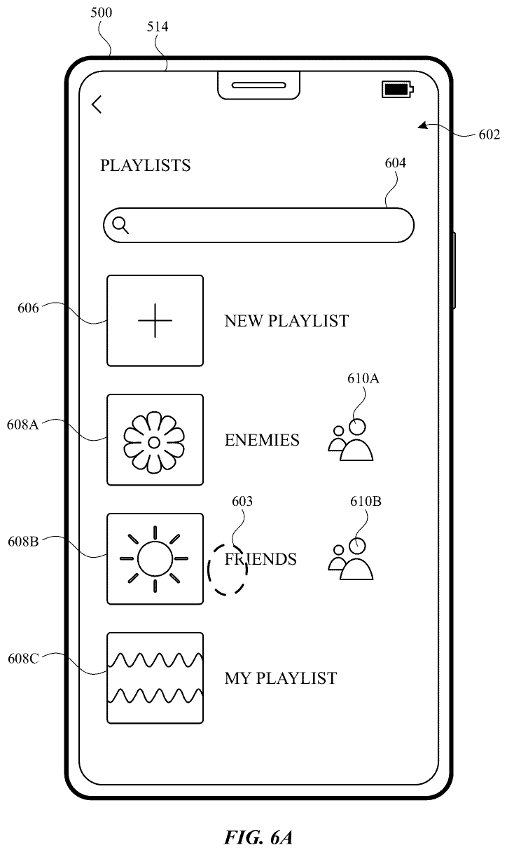

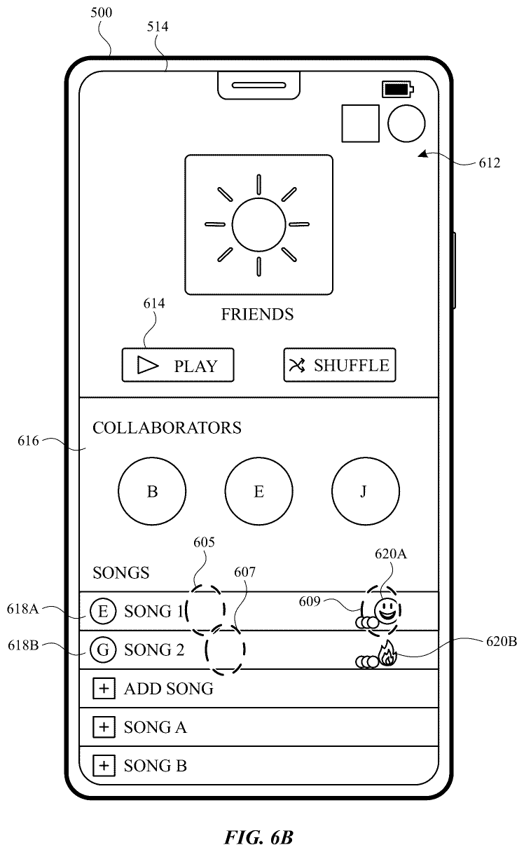

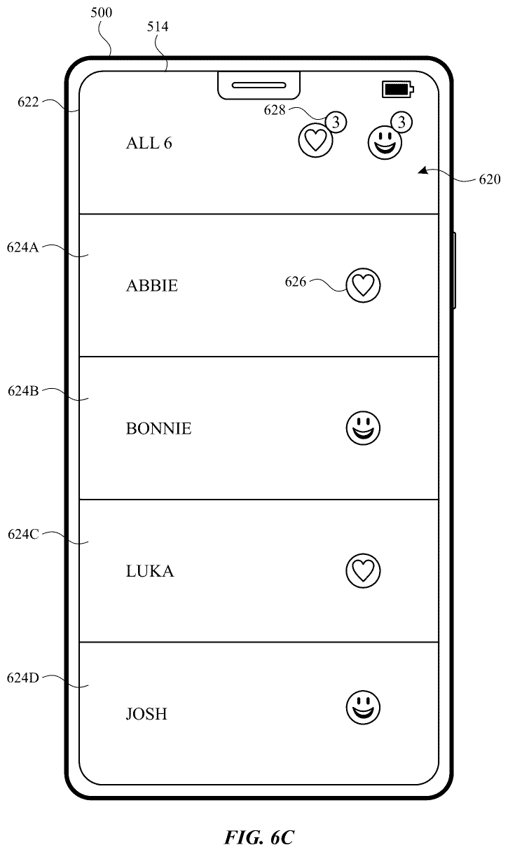

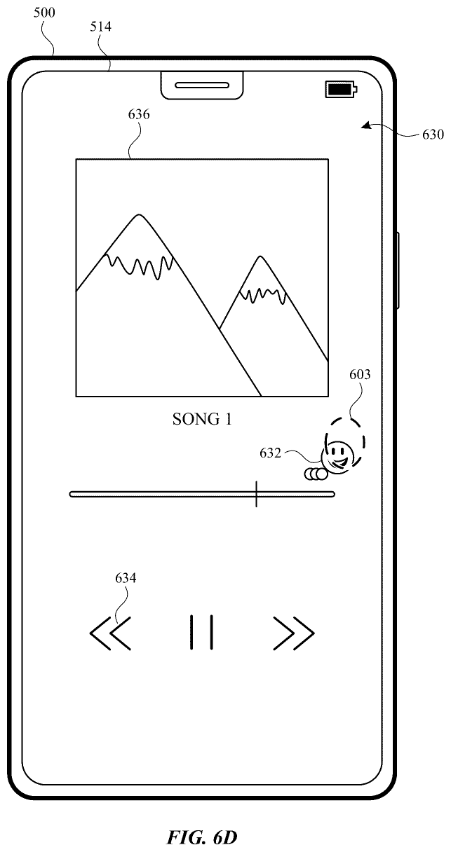

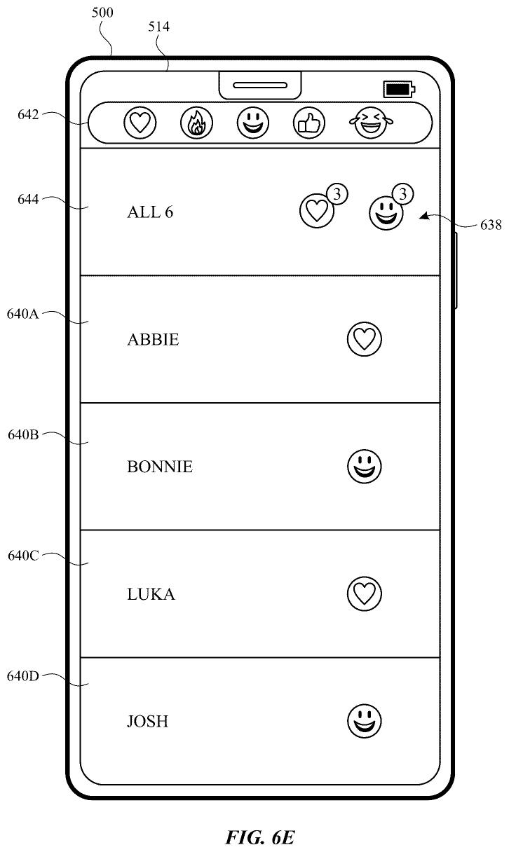

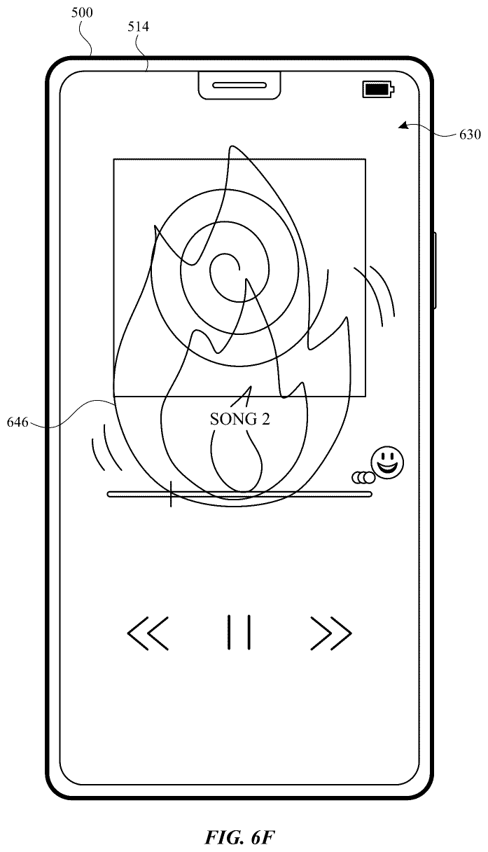

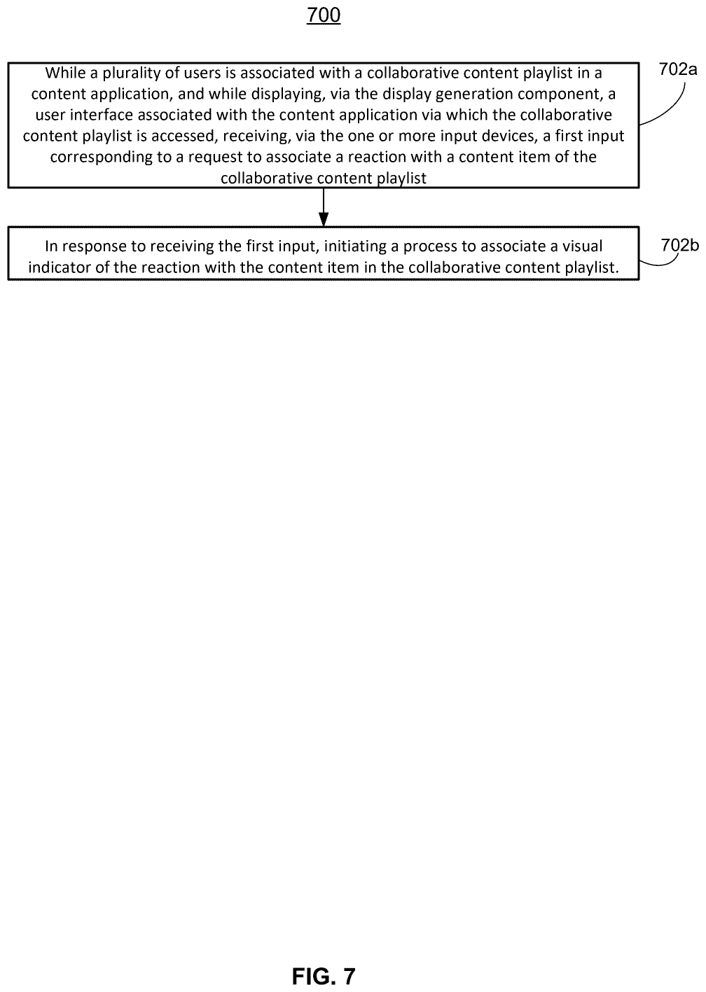

FIGS. 6A-6F illustrate exemplary ways in which an electronic device displays user interfaces for applying reactions to content items on a collaborative playlist of a content application. The embodiments in these figures are used to illustrate the processes described below, including the processes described with reference to FIG. 7. Although FIGS. 6A-6F illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6F.

FIG. 6A illustrates an exemplary device 500 displaying a user interface 602. In some embodiments, the user interface 602 is displayed via a display generation component. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, an electronic device (e.g., device 500) includes a content application. The content application provides one or more user interfaces that facilitate user interaction with content, including but not limited to, organizing content items and playing content items on the electronic device. For purposes of illustration, the examples below may be described in context of a music application, however the example context provided should not be viewed as limiting. Thus, the concepts and examples provided below should be understood to be applicable to all forms of content including video, still images, podcasts, etc. In some embodiments, the content application, and specifically the one or more user interfaces associated with the content application, facilitate organization of content items, by allowing the user to maintain one or more playlists of content item.

As shown in FIG. 6A, the electronic device 500 displays a playlist access user interface 602 (e.g., of a content application installed on device 500) on touch screen 504. In some embodiments, user interface 602 is any user interface that displays information about one or more playlists including one or more collaborative playlists. In FIG. 6A, the playlist access user interface includes one or more playlist entry portions 608a-c, with each playlist entry portion corresponding to a playlist stored on the electronic device and maintained by the content application. In some embodiments, each playlist entry portion 608a-c includes identifying information of the playlist associated with the playlist entry portion. For instance, each playlist entry portion 608a-c optionally includes a name of the playlist as well as a cover image associated with the playlist. In some embodiments, the cover image associated with the playlist is selected by a host or collaborator of the playlist. In some embodiments, the cover image associated with the playlist is suggested by to the user by the device based on content stored in the playlist. For instance, the cover image suggested by the device via the content application can be based on the tempo of the content items (e.g., when the content items are music files), a genre of the content items, or one or more content creators associated with the content items. In some embodiments, the cover image and name associated with a playlist is set by the user at the time that the playlist is created. Additionally or alternatively, the name and cover image can be added or modified by the user at any time after the playlist has been created.

As described above, in some embodiments, a playlist maintained by the content application can be created and maintained by the user of the electronic device alone, or alternatively can be created and/or maintained as a collaborative playlist (as described above). Additionally or alternatively, the collaborative playlist can be set up to be valid for a finite period of time or automatically be deleted or archived after a certain amount of time. In some implementations, the collaborative playlist can be shared with user devices that are within a pre-determined proximity of one another. When one collaborator user device is no longer within a threshold proximity of the host user device, the user device is removed from the collaborative playlist as a collaborator. The host user device may be prompted to remove the collaborator device that is no longer within the threshold proximity, or the collaborator device may automatically be removed once it is outside of the threshold proximity. In some embodiments, the collaborative playlist exisst within a communication session among user devices. Once the communication session ends, the collaborative playlist optionally also ends. Prior to the end of the communication session, the one or more of the collaborative user devices is optionally prompted to save the collaborative playlist so that it is accessible to user devices outside of the communication session. In some embodiments, the collaborative playlist may cease to be a collaborative playlist for a user device (e.g., after a finite period of time, after a communication session ends, after a user is no longer within a threshold proximity of the host user device). However, the user device may have the ability to access or save the playlist as a copy or as read-only. In some implementations, if the playlist is read-only, the user device may get updates to the playlist as the playlist changes but cannot edit the playlist. In other implementations, if the playlist is a copy, the user device may not get updates to the playlist as the playlist changes but may get a copy of the playlist at the time the user device obtains the playlist and may edit the copy of the playlist similar to other playlists in the user device's playlist library. In some embodiments, each playlist entry portion includes a visual indicator for indicating whether the playlist associated with the entry is a collaborative playlist. For instance, and as illustrated at FIG. 6A, playlist entry portions 608a and 608b include visual indicators 610a and 610b respectively that are configured to indicate that the playlist associated with the playlist entry portion is a collaborative. Optionally, a playlist that is not collaborative (for instance the playlist associated with playlist entry portion 608c) does not include a visual indicator, therefore indicating that the playlist is not a collaborative playlist.

In some embodiments, the playlist access user interface 602 includes a search portion 604 that is configured to receive user input (e.g., in the form of text) from the one or more input devices of the electronic device 500 and is configured to search the playlists maintained by the content application for content items or playlists that match the text provided by the user. In some embodiments, the playlist access user interface 602 includes a new playlist generation portion 606 for creating a new playlist. In some embodiments, the playlist generation portion 606 includes one or more selectable options for generating a new playlist. In response to detection selection of the one or more selectable options associated with new playlist generation portion 606, the device displays one or more user interfaces for facilitating creation of a new playlist by the user.

In some embodiments, each of the playlist entry portions 608a-c are selectable. In FIG. 6A, device 500 detects selection of playlist entry portion 608b (e.g., via tap of contact 603 on portion 608b) indicating selection of the “Friends” playlist. In response to detection the selection of portion 608b, device 500 displays a collaborative playlist user interface 612 of the content application as shown in FIG. 6B. In some embodiments, the collaborative playlist user interface 612 includes one or more selectable options for performing tasks or for accessing information associated with the collaborative playlist. For instance, collaborative playlist user interface includes one or more selectable playback controls 614 for controlling playback of the content associated with the collaborative playlist. Playback controls 614 optionally include a play button for sequentially playing (i.e., in the order that the content items are listed) the one or more content items associated with the collaborative playlist as well as a shuffle button for playing the one more content items associated with the collaborative playlist is a random or pseudo-random order.

In some embodiments, the collaborative playlist user interface 612 includes a collaborator information portion 616 for displaying and providing access to identifying information associated with each collaborator of the playlist as shown in FIG. 6B. The collaborator information portion optionally includes an avatar or photo associated with each collaborator of the collaborative playlist. Optionally, the collaborator information portion includes the name of each collaborator as well other information about the user that is relevant in the collaborative playlist context. In some embodiments, the collaborator information portion 616 includes one or more selectable options, with each selectable option associated with a collaborator of the playlist. In response to detecting selection of one of the selectable options of the collaborator information portion 616, the device displays additional information associated with the user.

In some embodiments, the collaborative playlist user interface 612 includes one or more content item portions 618a-b for displaying information associated with a content item that is part of the collaborative playlist. For instance, as illustrated in FIG. 6B, content item portions 618a-b include a name of the content item (e.g., Song 1, Song 2), an avatar associated with the user/collaborator who added the content item to the collaborative playlist, as well as one or more reactions 620a-b associated with the content item. As described in further detail below, the one or more collaborators and/or the host associated with the collaborative playlist can associate a reaction with a content item of the collaborative playlist. A reaction refers to a visual indicator that is configured to indicate the collaborator's like or dislike of a content item on the collaborative playlist. For instance, the visual indicator associated with a content item includes, but is not limited, a “like” reaction (e.g., a smile emoji), a “fire” reaction (e.g., a flame symbol) or any other visual indicator configured to indicate a collaborator's emotions about a content item on the collaborative playlist. In some embodiments, reactions 620a-b include a visual indicator associated with each reaction associated with the content item. Optionally, in response to a user associating a reaction with the content item, the visual indicator of the reaction 620a-b is updated to include a visual indicator associated with the new reaction in addition to the visual indicators associated with the reactions that were previously associated with the content item. Thus, the reaction 620a-b is continuously updated with visual indicators (e.g., displayed in a stacked manner) such that all of the reactions associated with the content item are included in the reaction 620a-b.

In some embodiments, the reactions 620a-b are selectable (e.g., via tap of contact 609 on reaction 620a). In response to detecting selection of a reaction 620a-b, the device 500 displays a reactions user interface 620 as illustrated in FIG. 6C. In some embodiments, reactions user interface 620 is configured to provide additional details associated with the reactions associated with a content item, beyond the visual indicators of the reactions 620a-b included in collaborative playlist user interface 612. For instance, reactions user interface 620 includes a reactions summary portion 622 for providing a summary of the reactions associated with a content item. Optionally, the reactions summary portion 622 includes one or more reaction tally elements 628 that provide a tally (e.g., a numerical representation) of the number of reactions associated with a particular reaction category. For instance, as illustrated in FIG. 6C, reaction tally element 628 indicates that three “heart” reactions and three “smile” reactions have been previously associated with the content item. In some embodiments, the reactions user interface 620 includes one or more collaborator portions 624a-d for indicating individual reactions associated with the content item. Optionally, the collaborator portions 624a-d include a representation of the name of the user/collaborator who associated a reaction to the content item, and optionally includes a visual indicator 626 of the reaction that the user/collaborator associated with the content item.

Returning to the example of FIG. 6B, the content item portions 618a-b included as part of collaborative playlist user interface 612 are selectable (e.g., via tap of contact 605 on reaction content item 618a). In response to detecting selection of a content item portion 620a-b, the device 500 displays a content playback user interface 630 for playing the content item as illustrated at FIG. 6D. In some embodiments, the device 500, concurrently with the display of content playback user interface 630 initiates playing of the content item associated with the content item portion selected at collaborative user interface 612. In some embodiments, content playback user interface 630 includes content identifying information portion 636 for providing information associated with the content item being played. For instance, identifying information portion 636 includes the name of the content item (e.g., the name of the song in the music context) as well as an image associated with the content item (for instance an album cover). Optionally, the content playback user interface 630 includes a content playback control portion 634 that includes one or more selectable options for managing playback of the content item. For instance, playback control portion 634 can include a play/pause selectable option, as well as one or more selectable options for advancing the content item being played (e.g., play the next song on the collaborative playlist or the previous song on the playlist.

In some embodiments, the content playback user interface includes one or more visual indicators of the reactions 632. The visual indicators of the reactions 632 are similar to the visual indicators of reactions 620a-b described above with respect to FIG. 6B. For instance, like reactions 620a-b, reactions 632 is optionally selectable (e.g., via tap of contact 603 on reaction 632). In some embodiments, and in response to detecting selection of reaction 632, the device displays a reaction addition user interface 638 as illustrated in FIG. 6E. In some embodiments, the reaction addition user interface 638 includes one or more portions that are substantially similar to reactions user interface 620 described above with respect to FIG. 6C. For instance, reactions addition user interface 638 includes reaction summary portion 644, and one or more collaborator portions 640a-d, that are substantially the same as reactions summary portion 622 and collaborator portions 624 described above with respect to FIG. 6C. In some embodiments, and in contrast to reactions user interface 620, reactions addition user interface 638 includes a reaction application portion 642 for associating a reaction with the content item. Reaction application portion optionally includes one or more selectable options for associating a new reaction to the content item. For instance, reaction association portion 642 includes one or more visual indicators associated with each of the possible reactions that the user can associate with the content item. In some embodiments, each visual indicator is selectable and in response to detecting selection of a visual indicator (e.g., via tap of a contact a visual indicator) the device associates the reaction associated with the visual indicator to the content item. Optionally, in accordance with selection of a visual indicator (e.g., a reaction) the device updates the visual indicators of reactions described above with respect to user interfaces 620 and 612 to reflect the newly added reaction.

Returning to the example of FIG. 6B, in response to a selection of content item portion (e.g., via tap of contact 607 on content item portion 618b), in some embodiments, the device displays content playback user interface 630 as illustrated at FIG. 6F. In some embodiments, the content playback user interface 630 includes a reaction animation 646 for providing an animation of a reaction previously associated with the content item. In some embodiments, the reaction animation 646 includes a pre-defined animation sequence associated with a reaction that was previously associated with the content item. For instance, and as illustrated at FIG. 6F, the content playback user interface 630 includes an animated “flame” associated with a “fire” reaction that was previously associated with the content item by another collaborator or host of the collaborative playlist. Optionally, each possible reaction that can be associated with a content item can have its own animation sequence associated with it that is played when content playback user interface 630 is displayed by the device. Optionally, once the animation sequence associated with a previously associated reaction has finished playing, the device ceases displaying the animation 646 such that the content playback user interface 630 appears similar to the example of FIG. 6D described above.

FIG. 7 is a flow diagram illustrating a method 700 of displaying and controlling a collaborative playlist associated with a content application in accordance with some embodiments. The method 700 is optionally performed at an electronic device such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to facilitate efficient display of a collaborative playlist and reactions associated with content items of a collaborative playlist according to some embodiments. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device in communication with a display generation component and one or more input devices. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by a vehicle (e.g., at an infotainment system of an automobile having or in communication with one or more display generation components and/or input devices).

In some embodiments, while a plurality of users is associated with a collaborative content playlist in a content application, and while the electronic device displays, via the display generation component, a user interface (such as user interface 630 in FIG. 6D) associated with the content application via which the collaborative content playlist is accessed, the electronic device receives (702a), via the one or more input devices, a first input such as the input at contact 603 in FIG. 6D, corresponding to a request to associate a reaction with a content item of the collaborative content playlist. In some embodiments, a collaborative content playlist includes a selectable list of multimedia content, wherein the list is generated and jointly edited by one or more users of the collaborative content playlist. Optionally, when the device detects that an entry corresponding to content on the selectable list has been selected by the user, the device initiates playback of the content on the device. Optionally, the collaborative content playlist includes audio (e.g., music) and/or visual (e.g., images and movies) content. In some embodiments the device initiates playback of the content on the device via the content application. Examples of a content application include, but are not limited to a music application, a video application, a podcast application, or any other application configured to play multimedia content. In some embodiments, a user of the one or more users (e.g., the host of the collaborative content playlist) generates the collaborative content playlist, and then invites one or more users (via an electronic message) to edit the playlist by adding to or removing content from the collaborative playlist. Optionally, the host is authorized to add users to and remove users from the collaborative content playlist, delete the playlist, make the playlist discoverable to one or more users not associated with the collaborative playlist, and edit information associated with the playlist. In some embodiments, the other users associated with the playlist (e.g., referred to as collaborators) are authorized to edit the content of the playlist by adding to or removing content to the playlist and remove themselves from playlist. In some embodiments, the user interface associated with the content application includes the selectable list of multimedia content. Optionally, each entry of the selectable list displayed on the user interface includes a selectable option to associate a reaction with the content item associated with entry of the selectable list. Optionally, the first input received at the electronic device corresponds to the selection of the selectable option by the user to associate a reaction with the content item. In some embodiments, when the device detects that an entry on the selectable list has been selected by the user, the device displays, via the display generation component, a content playback user interface. The content playback user interface includes one or more selectable options that are configured to allow the user to control the playback of the content of the device, including but not limited to, stopping the playback and rewinding or fast forwarding the playback. Optionally, the content playback user interface includes a selectable option to associate a reaction with the content that is selectable by the user. Thus, in some embodiments, the first input corresponds to selection of that selectable option included in the content playback user interface.

In some embodiments, in response to receiving the first input, the electronic device initiates (702b) a process to associate a visual indicator of the reaction with the content item in the collaborative content playlist such as the user interface illustrated in FIG. 6E. In some embodiments, in response to detecting selection of a selectable option to associate a reaction with the content (e.g., the first input), the device initiates the process to associate the visual indicator of the reaction with the content item in the collaborative playlist. In some embodiments, the visual indicator includes a still image representing the user's reaction. Additionally or alternatively, the visual indicator includes an animated image representing the user's reaction to the content item. As an example, a user can associate an emoji (e.g., a digital image that expresses an emotion) such as a happy face, sad face, an image of an object such as a heart or flame with a content item on the collaborative playlist. Alternatively or additionally, the user can apply animated emoji or objects to also indicate a reaction to a piece of content on the collaborative playlist. In some embodiments, each user associated with the collaborative playlist can associate their own visual indicator of their reaction with the content such that a content item on the collaborative playlist has multiple reactions and/or visual indicators associated with it, each visual indicator corresponding to an individual user's reaction to the content item. Optionally, both the host of the collaborative playlist and the collaborators of the collaborative playlist are able to associate a reaction (via a visual indicator) with the content items on the collaborative playlist. Maintaining visual indicators of user reactions to content items on a collaborative playlist, allows the device to efficiently organize and/or present a collaborative playlist thereby reducing the incident of erroneous user input on the device and preserving computing and memory resources of the device.

In some embodiments, the user interface associated with the content application via which the collaborative content playlist is accessed is a playback user interface such as the user interface at 6D, and wherein the playback user interface includes one or more selectable options (such as selectable options 634) to control playback of the content item. In some embodiments, the content application includes a playback user interface that is for controlling playback of a content item. For instance, in the example of the content item being an audio file (e.g. music), the playback user interface is used by the device to receive one or more inputs from a user of the device allowing the user to control the playback of the music file. In some embodiments, the playback user interface includes one or more selectable options to control the playback of the content item. Using the example of a music file, the one or more selectable options includes a play button that allows the device to initiate playback of the audio file, a pause button that allows the device to pause playback of the audio file, and one or more track change buttons that allow the device to change the audio file being played on the device. In some embodiments, the playback user interface includes the reactions associated with the content item that is being played on the device via the playback user interface. In an example where multiple users of the collaborative playlists (e.g., the collaborators and/or the host of the playlist) have applied reactions to the content item, the visual indicator associated with each reaction is included on the playback user interface. Thus, as the content item is being played by the device, the device contemporaneously displays the reactions associated with the content item. Displaying reactions to a content item on a content playback user interface, minimizes erroneous input on the device by making it more likely that reactions are applied to the correct content item, thereby preserving computing and memory resources of the device.

In some embodiments, the first input is received at a first selectable option of the playback user interface, and the first selectable option of the playback user interface includes one or more visual indicators (such as the visual indicators at 632 of FIG. 6C) displaying one or more reactions that have already been associated with the content item. In some embodiments, in response to detecting that the first selectable option has been selected, the device initiates a process to receive a reaction to the content item from the user of the device. In some embodiments, the first selectable option of the playback user interface includes one or more visual indicators associated with the reactions that have been previously associated with the content item. Optionally, each time a user of the collaborative playlist applies a reaction to a content item, the first selectable option of the playback user interface is updated by the device to include a visual indicator associated with the newly applied reaction (e.g., the most recent reaction to the content item). Thus, the first selectable option includes a visual indicator for one or more or each reaction applied to the content item, thereby allowing the device to provide the user with a record of all reactions applied to the content item. Displaying the reactions applied to a content item on a selectable option of the playback user interface for receiving user input to apply a new reaction to the content item, minimizes erroneous user input (e.g., the user can base their reaction on the reactions previously applied by other users), thereby conserving computing and memory resources of the device associated with correcting erroneous input.

In some embodiments, the electronic device displays the user interface associated with the content application while playing back a second content item that is not part of a collaborative content playlist, wherein the user interface does not include a selectable option via which a reaction can be associated with the second content item, such as displaying the user interface of FIG. 6D for playing a content item that is not part of a collaborative content playlist. In some embodiments, reactions are a feature associated with collaborative playlists, and are not employed in non-collaborative playlists. In some embodiments, when a content item being played via the playback user interface is not part of a collaborative playlist, the playback user interface will not include any portions associated with reactions. Thus, the playback user interface (e.g., the user interface) will not include a selectable option for receiving a reaction from the user of the device. Additionally, the playback user interface will not include one or more visual indicators associated with reactions previously applied to the content item, since for a content item that is part of a non-collaborative playlist, no reactions would have been previously applied. Forgoing reactions for non-collaborative playlists allows the device to conserve computing and memory resources that are needed to implement reactions on a content application.

In some embodiments, the process to associate a visual indicator of the reaction with the content item in the collaborative content playlist comprises displaying a plurality of visual indicators of a plurality of pre-determined reactions that are available to associate with the content item such as visual indicators 642 at FIG. 6E, and receiving, via the one or more input devices, a selection of a respective visual indicator of a respective pre-determined reaction from the plurality of pre-determined reactions. In some embodiments, the visual indicators associated with reactions to the content item include a still image representing the reaction. Thus, in some embodiments, the process to associate a visual indicator of a reaction with the content item, includes the device displaying a plurality of still images, with each still image associated with a reaction, and then detecting an input directed to a displayed still image to associate the reaction to the content item. In some embodiments, the displayed plurality of still images are selected from a pre-determined list of reactions that can be associated with a content item. For example, if a content application allows for a “like”, “love”, and “fire” reaction to be applied to any particular content item, then the device displays a pre-determined list of still images include a thumbs-up image associated with the “like” reaction, a heart image associated with the “love” reaction, and an image of a flame associated with the “fire” reaction. The device then detects selection of one of the images by the user, and in reaction to the detecting the user selection, associates the corresponding selected reaction to the content item. Providing a pre-determined list of visual indicators associated with reactions, limits the number of possible reactions that can be applied to a content item, thereby limiting the computing and memory resources associated with implementing reactions for content items.

In some embodiments, the content application comprises a collaborative playlist user interface that displays one or more content items associated with the collaborative playlist such as in FIG. 6B. In some embodiments, the collaborative playlist user interface includes one or more selectable entries such as selectable entries 618a and 618b, each selectable entry associated with a content item of the collaborative playlist. In some embodiments, while displaying the collaborative playlist user interface, the electronic device receives, via the one or more input devices, a second input corresponding to selection of a first selectable entry corresponding to a first content item in the collaborative playlist such as the input at contact 609 at FIG. 6B. In some embodiments, the second input has one or more characteristics of the first input. In some embodiments, in response to receiving the second input, the electronic device displays one or more visual indicators of one or more reactions associated with the first content item associated with the first selectable entry such as in FIG. 6C. In some embodiments, when the device detects an input (e.g., the second input) directed to a selectable entry associated with a content item, the device displays one or more or all of the reactions that have previously been applied to a content item such as reactions 624a-d in FIG. 6C. In some embodiments, the one or more selectable entries allows the device to display the past reactions associated with a content item, without requiring playback of the content item. Thus, the device can optionally display past reactions via the collaborative playlist user interface (described above) in addition to the playback user interface as described above. In some embodiments, upon detecting a selection of the one or more selectable entries, the device can display one or more or all of the past reactions as part of the user interface currently being displayed. Additionally or alternatively, the device can display past reactions to a content item by displaying a new user interface. In some embodiments, in addition to displaying one or more or all of the past reactions, the device also displays which users provided which reactions. Displaying previous reactions applied to a content item without requiring playback of the content item (e.g., from a playback user interface) conserves computing resources associated with content playback by not requiring the device to play the content item in order to view past reactions.

In some embodiments, the content application comprises a collaborative playlist user interface that displays one or more content items associated with the collaborative playlist such as in FIG. 6B. In some embodiments, the collaborative playlist user interface displays a collaborator list, such as collaborator list 616, that includes one or more representations of one or more users that are associated with the collaborative playlist. In some embodiments, the collaborative playlist user interface includes a listing of the content items associated with a collaborative playlist as well as information about the collaborative playlist. For instance, the information includes a collaborator list that includes a listing of the collaborators associated with the collaborative playlist. The list optionally represents each collaborator on the list using identifying information associated with the collaborator such as their name and/or an avatar. Displaying information about the users that are associated with a collaborative playlist, minimizes the possibility that an unauthorized user has accessed and added content to the collaborative playlist, and minimizes the susceptibility of the device to external malicious activity.

In some embodiments, the content application comprises a collaborative playlist user interface that displays one or more content items associated with the collaborative playlist such as in FIG. 6B. In some embodiments, the collaborative playlist user interface includes a representation of a first content item in the collaborative content playlist (such as content item 618a) and a representation of a second content item (such as content item 618b) in the collaborative content playlist. In some embodiments, the representation of the first content item is displayed in association with a representation of a user that added the first content item to the collaborative playlist (e.g., the “E” avatar displayed with content item 618a), and the representation of the second content item is displayed in association with a representation of a user that added the second content item to the collaborative playlist (e.g., the “G” avatar displayed with content item 618b). In some embodiments, the user interface is a collaborative playlist user interface (described above) the includes an entry for each content item that is part of the collaborative playlist. In some embodiments each entry associated with a content item of the collaborative playlist includes one or more representations indicating the user that added the content item to the playlist. For instance, the representation of the user includes an avatar of the user and/or the name of the user who added the content item. Optionally, the representation of the user on the user interface is selectable, and when the device detects selection of the representation, the device displays information pertaining to the user such as contact information of the user. Displaying information about which user has contributed a particular content item to a collaborative playlist, minimizes the possibility that an unauthorized user has accessed and added content to the collaborative playlist, and minimizes the susceptibility of the device to external malicious activity.

In some embodiments, the electronic device receives, via the one or more input devices, a second input, such as the input from contact 607 in FIG. 6B, corresponding to a request to initiate playback of a respective content item of the collaborative playlist. In some embodiments, the second input has one or more characteristics of the first input. In some embodiments, in response to receiving the second input, the electronic device displays, via the display generation component, an animation, wherein the animation is based on a reaction associated with the respective content item such as in FIG. 6F. In some embodiments, in response to detecting the second input, the device displays a playback user interface that is configured to control playback of the content item on the device (described above). In some embodiments, when the device initially displays the playback user interface, the device overlays an animation onto the playback user interface that is associated with a reaction to the content item being played. For instance, if the reaction is a “fire” reaction, then upon displaying the playback user interface, the device displays an animation sequence of a flame. If the reaction were a different reaction (e.g., other than a fire reaction) a different animation corresponding to the that reaction would optionally be played by the device. Optionally, the animation is played when the playback user interface is initially displayed by the device and then is removed from being displayed once the animation sequence has ended. Optionally, the animation sequence is faded out from being displayed (e.g., the visual prominence of the animation is reduced over a time duration until the animation no longer appears on the display). In some embodiments, the device plays an animation sequence associated with the last added reaction and does not play an animation sequence associated with other previously associated reactions. Additionally or alternatively, the device plays an animation sequence for all or some of the reactions associated with the content item. The animation sequences are optionally played either sequentially or concurrently. Additionally or alternatively, the device plays one or more animation sequences (e.g., sequentially or concurrently) for the reactions that have been associated with the content item since the last time the user played the content item. Displaying an animation associated with a content item while playing the content item, provides a visually prominent manner to provide reaction information to the user of the device, thereby minimizing the likelihood that the user will not notice or be aware of past reactions associated with the content item, and thereby minimizing erroneous interactions with the content application, thereby conserving computing resources associated with correcting the erroneous interactions.

In some embodiments, the collaborative playlist user interface includes a content addition selectable entry, such as the “Add Song” selectable entry in FIG. 6B. In some embodiments, the content addition selectable entry included with the collaborative playlist user interface includes one or more visual indicators indicating that selectable entry if selected will initiate a process to add a content item to the collaborative playlist. For instance, the one or more visual indicators includes a plus symbol and text that is configured to indicate that selection of the content addition selectable entry will initiate a process to add a content item to collaborative playlist. In some embodiments, the electronic device detects, via the one or more input devices, selection of the content addition selectable entry such as if the “Add Song” selectable entry illustrated in FIG. 6B were selected. In some embodiments, selection of the content addition selectable entry has one or more characteristics of the first input. In some embodiments, the content addition selectable entry includes a visual indicator for indicating that selection of the entry will initiate a process to add a content item to the collaborative playlist. For instance, the visual indicator is a plus button or other symbol indicating that the content addition selectable entry is for adding a content item to the collaborative playlist, without indicating a particular content item to be added (e.g., further user input will be required to indicate which content item to be added in response to selection of the content addition selectable entry). In some embodiments, in response to detecting the selection of the content addition selectable entry, the electronic device initiates a process to add a respective content item to the collaborative playlist such as in response to selection of the “Add Song” selectable entry illustrated in FIG. 6B. In some embodiments, the process to add a respective content item to the collaborative playlist includes receiving user input (e.g., receiving text from the user) indicating the name of a content item to add to the collaborative playlist. In response to receiving the user input the device optionally accesses an external server or internal memory of the device where one or more content items that are not part of the collaborative playlist are stored and uses the text input by the user to search for a content item that most closely matches the text provided by the user. Upon determining a matching content item, the device optionally displays a representation of the matching content item that is selectable by the user. In some embodiments, in response to detecting selection of the representation of the matching content item, the device adds the content item to the collaborative playlist. Providing the content addition selectable entry as part of the collaborative playlist user interface that includes a listing of content items already associated with the playlist, minimizes the likelihood of adding duplicative content items to a playlist thereby conserving memory resources associated with the storage of duplicative content items on the same collaborative playlist.

In some embodiments, the respective content item is suggested by the electronic device such as “Song A” and “Song B” in FIG. 6B. In some embodiments, in addition to or alternatively to receiving text from the user, the device displays one or more selectable entries associated with content items that are stored on the device or stored on an external server accessed by the device that are not already associated with the collaborative playlist. In some embodiments, the device “suggests” the content items based on information associated with content items that are associated with collaborative playlist. For instance, the device suggests content items to be added to the collaborative playlist based on the genres of content items associated with the playlist, the artists or content creators associated with the content items, the tempo of the content items on the collaborative playlist (in the case of music), or any other information about the content items that can be used to determine one or more commonalities between the content items on the collaborative playlist. For instance, if the collaborative playlist includes multiple content items from a common artist/content creator, then the device suggests additional content items associated with artist that are not already associated with the collaborative playlist. By providing one or more suggestions of content items to be added to the playlist, the device can minimize the amount of time and computing resources expended in searching for content based on user input, thus preserving computing and memory resources associated with text-based searching.

In some embodiments, the electronic device receives, via the one or more input devices, a second input corresponding to a request to share the collaborative content playlist with a respective user such as receiving a selection of a selectable option included in user interface 612 of FIG. 6B. In some embodiments, the second input has one or more characteristics of the first input. In some embodiments, the collaborative playlist can be shared with one or more users who are not already collaborators on the collaborative playlist, thereby giving those users access to view and play the content items associated with the collaborative playlist. Optionally, the one or more users that the collaborative playlist has been shared with are permitted to edit (e.g., add or remove content items to collaborative playlist). Additionally or alternatively, the one or more users that the collaborative playlist has been shared with can view and play the content items on the collaborative playlist, but are not permitted to modify the collaborative playlist. In some embodiments, in response to receiving the second input and in accordance with a determination that the second input specifies a first application via which to share the collaborative content playlist with the respective user, the electronic device initiates a process to share the collaborative content playlist with the respective user via the first application such as in response to receiving a selection of a selectable option for sharing the collaborative playlist included in user interface 612 of FIG. 6B. In some embodiments, and in accordance with a determination that the second input specifies a second application, different from the first application, via which to share the collaborative content playlist with the respective user, the electronic device initiates a process to share the collaborative content playlist with the respective user via the second application. In some embodiments, in response to receiving the second input, the device generates a “sharing link” (e.g., a web-based link) that is provided to one or more external users giving them access to the collaborative playlist. Optionally, sharing the collaborative playlist via the web-based link includes the option to specify whether anyone who accesses the web-based link can have access to the collaborative playlist. Additionally or alternatively, sharing the collaborative playlist via the web-based link includes the option to specify that only the recipients of the web-based link specified by the user of the device can collaborate. In some embodiments, the device uses the application associated with the content item and/or collaborative content playlist to share the content item. For instance if the application is a music content item, then the device will use a music application to share the collaborative playlist. Similarly, if the content item is a movie, then the device will use a movie application to share the collaborative playlist. In some embodiments, in response to detecting the second input, the device provides the user with one or more options of software applications to use to share the content. For instance, in response to receiving an input to share a photo, the device provides the user the option to share the photo via an email application and/or a messaging application. In response to detecting selection of the application to use to share a content item, the device uses the selected application to share the content item. Allowing the collaborative playlist to be shared, while allowing the user to control who can access the collaborative playlist, allows the device to secure the collaborative playlist from unauthorized access and modification, thereby minimizing computing resources associated with securing a collaborative playlist.

In some embodiments, the electronic device receives, via the one or more input devices, a second input corresponding to a request to share a respective content item with a respective user such as receiving a selection of a selectable option included in user interface 612 of FIG. 6B. In some embodiments, the second input has one or more characteristics of the first input. In some embodiments, in response to receiving the second input, and in accordance with a determination that the respective content item is a content item other than a content item included in a collaborative playlist, the electronic device displays, via the display generation component, a sharing user interface that includes one or more selectable options for initiating sharing of the respective content item in one or more manners such as in response to receiving a selection of a selectable option for sharing the collaborative playlist included in user interface 612 of FIG. 6B. In some embodiments, the user interface includes one or more selectable options to share content items that are not part of the collaborative playlist (in addition to one or more selectable options to share content items that are part of the collaborative playlist). In some embodiments, the content items that are not part of the collaborative playlist is a content item from the content application or a different application such as a photos application, a messaging application, an email application, a web browser application, etc. In accordance with the determination that the respective content item is a content item that is not associated with the collaborative playlist, the device displays a sharing user interface that is configured to allow the device to share the content item with other external users. Optionally, the content items that are not part of the collaborative playlist include content items that are not associated with the content application that the collaborative playlist is associated with. In such instances, the sharing user interface includes one or more selectable options that when the device detects have been selected initiates sharing of the content item according the software application associated with the content item. For instance, the content item not associated with the content application, or the collaborative application is shared using a messaging application or another application that is not the content application associated with the collaborative playlist. Additionally or alternatively, the user interface used to share the content items described above is a user interface associated with the operating system of the device, rather than a user interface associated with any particular application.

In some embodiments, and in accordance with a determination that the respective content item is a content item included in the collaborative playlist, the electronic device displays, via the display generation component, the sharing user interface that includes one or more selectable options for initiating sharing of the respective content item in the one or more manners such as in response to receiving a selection of a selectable option for sharing the collaborative playlist included in user interface 612 of FIG. 6B. In some embodiments, in accordance with the determination that the content item is included in the collaborative playlist, the sharing user interface includes one or more selectable options, that when the device detections selection of, initiates a process to share the respective content item in a manner commensurate with the content application associated with the collaborative playlist. In some embodiments, the sharing user interface utilized when the content item is a content item included in the collaborative playlist, is the same sharing user interface that is used when the content item is not included in the collaborative playlist and includes the same selectable sharing options. Providing a single user interface to share content items that are associated with different applications of the device, allows the device to minimize the amount of user input required to share content items, thereby minimizing the likelihood of erroneous user input, thus preserving computing resources and memory resources associated with correcting erroneous user input.

In some embodiments, the electronic device receives, via the one or more input devices, a second input corresponding to a request to add a respective user to the collaborative playlist such as receiving a selection of a selectable option for adding a user to the collaborative playlist included in collaborator information portion 616 of FIG. 6B. In some embodiments, the second input has one or more characteristics of the first input. In some embodiments, and in response to receiving the second input, the electronic device initiates a process to add the respective user to the collaborative playlist, wherein: in accordance with a determination that the respective user has a profile associated with a content service associated with the collaborative playlist, the respective user is identified in the collaborative playlist based on the profile such as at collaborator information portion 616 of FIG. 6B. In some embodiments, the content service associated with the collaborative playlist maintains user profiles for each user associated with the content service. The content service refers to the service via which the content items in the playlist are played/consumed. Optionally, the user profiles include identifying information associated with each user. Examples of identifying information include, but are not limited to, an email address, a phone number, or other electronic messaging information associated with the user. In some embodiments, if the device determines that a user to be added to a collaborative playlist (e.g., as a collaborator) is associated with a profile maintained by the content service, the device uses the identifying information associated with the profile to identify the user and directs some or all communications with the new user using the identifying information associated with the profile.

In some embodiments, and in accordance with a determination that the respective user does not have a profile associated with the content service associated with the collaborative playlist, the respective user is identified in the collaborative playlist based on identifying information provided by the respective user during the process to add the respective user to the collaborative playlist such as at collaborator information portion 616 of FIG. 6B. In some embodiments, and in the event that the user to be added is not associated with a profile that is maintained or stored by the content service, the device of the user to be added prompts the user to be added to manually add identifying information for the user (e.g., an external user and not the user of the device) that the device uses to identify the user to be added. In some embodiments, once the user to be added provides identifying information for the user to be added, the content service stores the identifying information in the memory of the device or on an external device (such as a server) so that the identifying information can be used for any interactions with the user to be added by the content service, including but not limited to sending messages to the user to be added from the content service. Storing profiles on the device that are automatically associated with a user to be added to a collaborative playlist, such that the user of the device is not always required to manually enter identifying information for each user they add to the collaborative playlist, minimizes the amount of input required by the user of the device to add a user to the collaborative playlist, thereby minimizing the likelihood of erroneous input by the user and thereby conserving computing resources and memory resource required to receive and store the user input and/or correct the user input.

In some embodiments, while displaying a collaborative playlist user interface that displays one or more content items associated with the collaborative playlist, the electronic device displays, in the collaborative playlist user interface, a cover image associated with the collaborative content playlist that is selected by a creator of the collaborative playlist, such as “sun image” in FIG. 6B. In some embodiments, the collaborative user interface includes a cover image that is associated with the collaborative playlist and provides a visual means to identify the collaborative playlist. In some embodiments, the cover image is selected by the host or the one or more collaborators of the collaborative playlist at the time when the collaborative playlist is created, or alternatively is applied to the collaborative playlist during a process in which identifying information associated with the collaborative playlist is modified by one or more of the collaborators associated with the collaborative playlist. Associating a cover image with the collaborative playlist, allows the device to provide a visual means to identify the playlist, thereby minimizing the likelihood that the user misidentifies the collaborative playlist, and minimizing the likelihood of the user erroneously interacting with the wrong playlist (collaborative or otherwise), thereby preserving computing resources and memory resources associated with any erroneous input.

In some embodiments, the electronic device creates the collaborative playlist, including displaying one or more representations of one or more suggested cover images for the collaborative playlist, including the cover image, that have one or more characteristics based on one or more content items included in the collaborative content playlist such as the “sunshine” image in FIG. 6B. In some embodiments, in addition to allowing the user to manually select a cover image to associate with the collaborative playlist, the device suggests one or more cover images to associate with the collaborative playlist based on one or more characteristics of the content items associated with the collaborative playlist. For instance, if the content is music, the suggested cover image is based on the tempo of the music in the playlist, the genre of the music in the playlist, or other identifying information associated with the collaborative playlist such as the playlist title. In some embodiments, the suggested cover image includes a color that is based on the characteristics of the content items in the playlist, and/or an image that is based on the characteristics of the content items in the playlist. In some embodiments, the device detects selection of the one or more suggested cover images and in response, associates the selected cover image with the playlist. Providing the user with suggested cover images, minimizes the amount of user input required to associate a cover image with the collaborative playlist, thereby preserving computing resources and memory associated with receiving manual input from the user to add a cover image to associate with a collaborative playlist.

It should be understood that the particular order in which the operations in method 700 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, receiving operation 702a and initiating operation 702b, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display content or suggest content for display to users. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data in the present technology can be used to the benefit of users. For example, the personal information data can be used to automatically perform operations with respect to interacting with a collaborative playlist on a content application. Accordingly, use of such personal information data enables users to enter fewer inputs to perform an action with respect to displaying and interacting with content. Further, other uses for personal information data that benefit the user are also contemplated by the present disclosure. For instance, user preferences may be used to suggest content items for a collaborative playlist.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's preferences when suggesting content items for the collaborative playlist.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content items for the collaborative playlist can be suggested based on aggregated non-personal information data or a bare minimum amount of personal information, such as the user preferences being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while a plurality of users is associated with a collaborative content playlist in a content application, and while displaying, via the display generation component, a user interface associated with the content application via which the collaborative content playlist is accessed, receiving, via the one or more input devices, a first input corresponding to a request to associate a reaction with a content item of the collaborative content playlist; and
in response to receiving the first input, initiating a process to associate a visual indicator of the reaction with the content item in the collaborative content playlist.

2. The method of claim 1, wherein the user interface associated with the content application via which the collaborative content playlist is accessed is a playback user interface, and wherein the playback user interface includes one or more selectable options to control playback of the content item.

3. The method of claim 2, wherein the first input is received at a first selectable option of the playback user interface, and wherein the first selectable option of the playback user interface includes one or more visual indicators displaying one or more reactions associated with the content item.

4. The method of claim 1, further comprising:
displaying the user interface associated with the content application while playing back a second content item that is not part of a collaborative content playlist, wherein the user interface does not include a selectable option via which a reaction can be associated with the second content item.

5. The method of claim 1, wherein the process to associate a visual indicator of the reaction with the content item in the collaborative content playlist comprises displaying a plurality of visual indicators of a plurality of pre-determined reactions that are available to associate with the content item, and receiving, via the one or more input devise, a selection of a respective visual indicator of a respective pre-determined reaction from the plurality of pre-determined reactions.

6. The method of claim 1, wherein the content application comprises a collaborative playlist user interface that displays one or more content items associated with the collaborative playlist, wherein the collaborative playlist user interface includes one or more selectable entries, each selectable entry associated with a content item of the collaborative playlist, the method further comprising:
while displaying the collaborative playlist user interface, receiving, via the one or more input devices, a second input corresponding to selection of a first selectable entry corresponding to a first content item in the collaborative playlist; and
in response to receiving the second input, displaying one or more visual indicators of one or more reactions associated with the first content item associated with the first selectable entry.

7. The method of claim 1, wherein the content application comprises a collaborative playlist user interface that displays one or more content items associated with the collaborative playlist, and wherein the collaborative playlist user interface displays a collaborator list that includes one or more representations of one or more users that are associated with the collaborative playlist.

8. The method of claim 1, wherein the content application comprises a collaborative playlist user interface that displays one or more content items associated with the collaborative playlist, and wherein the collaborative playlist user interface includes a representation of a first content item in the collaborative content playlist and a representation of a second content item in the collaborative content playlist, the representation of the first content item is displayed in association with a representation of a user that added the first content item to the collaborative playlist, and the representation of the second content item is displayed in association with a representation of a user that added the second content item to the collaborative playlist.

9. The method of claim 1, the method comprising:
receiving, via the one or more input devices, a second input corresponding to a request to initiate playback of a respective content item of the collaborative playlist; and
in response to receiving the second input, displaying, via the display generation component, an animation, wherein the animation is based on a reaction associated with the respective content item.

10. The method of claim 6, wherein the collaborative playlist user interface includes a content addition selectable entry, the method further comprising:
detecting, via the one or more input devices, selection of the content addition selectable entry; and
in response to detecting the selection of the content addition selectable entry, initiating a process to add a respective content item to the collaborative playlist.

11. The method of claim 10, wherein the respective content item is suggested by the electronic device.

12. The method of claim 1, further comprising:
receiving, via the one or more input devices, a second input corresponding to a request to share the collaborative content playlist with a respective user; and
in response to receiving the second input:
in accordance with a determination that the second input specifies a first application via which to share the collaborative content playlist with the respective user, initiating a process to share the collaborative content playlist with the respective user via the first application; and
in accordance with a determination that the second input specifies a second application, different from the first application, via which to share the collaborative content playlist with the respective user, initiating a process to share the collaborative content playlist with the respective user via the second application.

13. The method of claim 1, further comprising:
receiving, via the one or more input devices, a second input corresponding to a request to share a respective content item with a respective user; and
in response to receiving the second input:
in accordance with a determination that the respective content item is a content item other than a content item included in a collaborative playlist, displaying, via the display generation component, a sharing user interface that includes one or more selectable options for initiating sharing of the respective content item in one or more manners; and
in accordance with a determination that the respective content item is a content item included in the collaborative playlist, displaying, via the display generation component, the sharing user interface that includes one or more selectable options for initiating sharing of the respective content item in the one or more manners.

14. The method of claim 1, further comprising:
receiving, via the one or more input devices, a second input corresponding to a request to add a respective user to the collaborative playlist; and
in response to receiving the second input, initiating a process to add the respective user to the collaborative playlist, wherein:
in accordance with a determination that the respective user has a profile associated with a content service associated with the collaborative playlist, the respective user is identified in the collaborative playlist based on the profile; and
in accordance with a determination that the respective user does not have a profile associated with the content service associated with the collaborative playlist, the respective user is identified in the collaborative playlist based on identifying information provided by the respective user during the process to add the respective user to the collaborative playlist.

15. The method of claim 1, further comprising while displaying a collaborative playlist user interface that displays one or more content items associated with the collaborative playlist, displaying, in the collaborative playlist user interface, a cover image associated with the collaborative content playlist that is selected by a creator of the collaborative playlist.

16. The method of claim 15, further comprising:
creating the collaborative playlist, including displaying one or more representations of one or more suggested cover images for the collaborative playlist, including the cover image, that have one or more characteristics based on one or more content items included in the collaborative content playlist.

17. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
while a plurality of users is associated with a collaborative content playlist in a content application, and while displaying, via the display generation component, a user interface associated with the content application via which the collaborative content playlist is accessed, receiving, via the one or more input devices, a first input corresponding to a request to associate a reaction with a content item of the collaborative content playlist; and
in response to receiving the first input, initiating a process to associate a visual indicator of the reaction with the content item in the collaborative content playlist.

18. A non-transitory computer readable storage medium storing one or more programs, the one or more programs comprising instructions, which when executed by one or more processors of an electronic device, cause the electronic device to perform a method comprising:
while a plurality of users is associated with a collaborative content playlist in a content application, and while displaying, via the display generation component, a user interface associated with the content application via which the collaborative content playlist is accessed, receiving, via the one or more input devices, a first input corresponding to a request to associate a reaction with a content item of the collaborative content playlist; and
in response to receiving the first input, initiating a process to associate a visual indicator of the reaction with the content item in the collaborative content playlist.

19. An electronic device that is in communication with a display generation component and one or more input devices, the electronic device comprising:
one or more processors;
a memory;
means for while a plurality of users is associated with a collaborative content playlist in a content application, and while displaying, via the display generation component, a user interface associated with the content application via which the collaborative content playlist is accessed, receiving, via the one or more input devices, a first input corresponding to a request to associate a reaction with a content item of the collaborative content playlist; and
means for in response to receiving the first input, initiating a process to associate a visual indicator of the reaction with the content item in the collaborative content playlist.

20-22. (canceled)
